(19) United States
(12) Patent Application Publication
(10) Pub. No.: US 2026/0350260 A1
(43) Pub. Date: Nov. 5, 2026

(54) PRESS FORMED PART SHAPE PREDICTION METHOD AND PRESS FORMED PART SHAPE PREDICTION APPARATUS

(71) Applicant: JFE STEEL COPRORATION, Tokyo (JP)

(72) Inventors: Masaki URABE, Tokyo (JP); Taira NAKAMOTO, Tokyo (JP); Yusuke FUJII, Tokyo (JP)

(73) Assignee: JFE STEEL COPRORATION, Tokyo (JP)

(21) Appl. No.: 19/123,528

(22) PCT Filed: Sep. 12, 2023
(86) PCT No.: PCT/JP2023/033174

§ 371 Date: Apr. 23, 2025

(30) Foreign Application Priority Data
Nov. 7, 2022 (JP) 2022-177778

(51) Int. Cl. G06F 30/20; G06F 111/10; G06F 113/24; G06F 119/18

(52) U.S. Cl. CPC G06F 30/20; G06F 2111/10; G06F 2113/24; G06F 2119/18

(57) ABSTRACT

A press formed part shape prediction method includes: measuring, at least at two timings in a predetermined time elapsed from immediately after die release, a shape variation amount of a specific portion of a press formed part at each timing; specifying coefficients a1 and b1 based on measurement results; and obtaining Xf, which is a prediction value of the shape variation amount of the specific portion in the press formed part whose shape has become stable, by substituting a time tf set in advance according to the timing of measurement of the shape variation amount into Equation (2),

x=a×log(t)+b (1)
where t is an elapsed time from immediately after die release, and
x is a shape variation amount at time t,

Xf=a1×log(tf)+b1 (2).

### FIELD

The present invention relates to a press formed part shape prediction method and a press formed part shape prediction apparatus for predicting a shape of a press formed part whose shape has become stable after the shape changes with the lapse of time after springback instantaneously occurring immediately after die release in press forming of a metal sheet.

### BACKGROUND

Press forming is a manufacturing method capable of manufacturing a metal part at low cost in a short time, and is used for manufacturing many automotive parts. In recent years, in order to achieve both collision safety of an automobile and weight reduction of a vehicle body, a metal sheet having higher strength has been used for the automotive parts. One of the main problems in press-forming the high-strength metal sheet is deterioration of dimensional accuracy due to springback. A phenomenon in which stress generated when the metal sheet is deformed by press forming becomes a driving force to cause the metal sheet to return to a shape before being processed like a spring is called springback.

The stress generated at the time of press forming is larger with higher strength of the metal sheet, thereby the shape variation due to springback also increases. Therefore, it is more difficult to keep the shape after springback within a prescribed dimension as the steel sheet has higher strength. Therefore, in a press formed part production line, a trial press formed part which is an actual press formed part is produced, and then the dimension is measured. In a case where the dimensional accuracy does not satisfy the standard, correction of a die or adjustment such as changing a forming condition such as a processing load is performed.

Generally, the dimensional accuracy of the actual press formed part is measured by a method in which a gap amount between an inspection jig and a formed part is measured after the formed part is installed in a dedicated inspection jig, or by a method in which a three-dimensional shape of a formed part is measured and compared with normal-size shape data on a computer (see Non Patent Literature 1).

However, in the actual press formed part, it is known that shape variation occurs with the lapse of time immediately after springback after die release (see Patent Literature 1). It takes at least 30 minutes or more to achieve a stable state (stable shape) in which the shape variation hardly occurs in the actual press formed part that has been die-released and sprung back. For this reason, Patent Literature 1 discloses a method for measuring the shape of a press formed part after being left for 30 minutes or more after being die-released.

### CITATION LIST

### Patent Literature

Patent Literature 1: Japanese Patent No. 6981487

### Non Patent Literature

Non Patent Literature 1: Handbook of Ease or Difficulty in Press Forming Third Edition, edited by Japan Sheet Metal Forming Research Group, P. 341-342

### SUMMARY

### Technical Problem

However, from the viewpoint of productivity, there has been a demand for a method capable of easily predicting a stable shape of an actual press formed part without waiting for 30 minutes or more after die-releasing the actual press formed part.

The present invention has been made to solve the above problems, and an object of the present invention is to provide a press formed part shape prediction method and a press formed part shape prediction apparatus capable of easily predicting a stable shape of a press formed part from a shape measurement result in several seconds to several minutes after forming.

### Solution to Problem

A press formed part shape prediction method according to the present invention predicts a shape of a press formed part whose shape has become stable after the shape changes with a lapse of time after springback instantaneously occurring immediately after die release in press forming of a metal sheet, and includes: a coefficient specifying step of measuring, at least at two timings in a predetermined time that has elapsed from immediately after die release, a shape variation amount of a specific portion of the press formed part at each timing, and specifying coefficients a and b in Equation (1) as coefficients a1 and b1 based on measurement results; and a prediction value calculating step of obtaining Xf, which is a prediction value of the shape variation amount of the specific portion in the press formed part whose shape has become stable, by substituting a time tf set in advance according to the timing of measurement of the shape variation amount into Equation (2),

$$x = a \times log ( t ) + b \qquad ( 1 )$$

where t is an elapsed time from immediately after die release, and
x is a shape variation amount at time t,

$$Xf = a 1 \times log ( tf ) + b 1 \qquad ( 2 )$$

where tf is a time set in advance, and
a1 and b1 are values specified in the coefficient specifying step.

In the prediction value calculating step, tf may be set to a numerical value in a range of 4400 to 7800 seconds in a case where the two timings are within 120 seconds immediately after die release, and tf may be set to a numerical value in a range of 7900 to 31000 seconds in a case where the two timings are from 120 seconds to 1800 seconds immediately after die release.

The shape variation amount measured in the coefficient specifying step may be one of: a variation amount of a distance between two points of the press formed part; a variation amount of a distance between one point of the press formed part and one point of a reference jig; a variation amount of an angle between a line segment between two points of the press formed part and a line segment between two points of the reference jig; a variation amount of a curvature of a surface of the press formed part; or a variation amount of an angle formed by line segments between two sets of two points sandwiching one or more bend ridges in the press formed part.

A press formed part shape prediction apparatus according to the present invention predicts a shape of a press formed part whose shape has become stable after the shape changes with a lapse of time after springback instantaneously occurring immediately after die release in press forming of a metal sheet, and includes: a time measurement unit configured to measure an elapsed time from immediately after die release; a shape measurement unit configured to measure, at least at two timings in a predetermined time that has elapsed from immediately after the die release, a shape variation amount of a specific portion of the press formed part at each timing, and record a measurement timing, a measurement portion, and a measurement value; and a prediction value calculation unit configured to specify coefficients a and b in Equation (1) as coefficients a1 and b1 based on a measurement result of the shape measurement unit, and obtain Xf, which is a prediction value of the shape variation amount of the specific portion in the press formed part whose shape has become stable, by substituting a time tf set in advance according to the timing of measurement of the shape variation amount into Equation (2),

$$x = a \times log ( t ) + b \qquad ( 1 )$$

where t is an elapsed time from immediately after die release, and
x is a shape variation amount at time t,

$$Xf = a 1 \times log ( tf ) + b 1 \qquad ( 2 )$$

where tf is a time set in advance, and
a1 and b1 are values specified in a coefficient specifying step.

### Advantageous Effects of Invention

According to the present invention, it is possible to predict a stable shape of a press formed part without waiting for a time (for example, 30 minutes) during which the dimension is to be generally stabilized after die release. Whether the stable shape of the press formed part finally achieves the target dimensional accuracy can be predicted at an early stage.

### BRIEF DESCRIPTION OF DRAWINGS

FIG. 1 is an explanatory diagram of a press formed part shape prediction method according to a first embodiment.

FIG. 2 is an explanatory diagram of a press formed part shape prediction apparatus according to a second embodiment.

FIG. 3 is an explanatory diagram of a specific configuration of a shape measurement unit in the press formed part shape prediction apparatus illustrated in FIG. 2.

FIG. 4 is a diagram for describing the background leading to the present invention (part 1).

FIG. 5 is a diagram for describing the background leading to the present invention (part 2).

FIG. 6 is a diagram for describing the background leading to the present invention (part 3).

FIG. 7 is a diagram for describing the background leading to the present invention (part 4).

FIG. 8 is an explanatory view of a shape and specific portions of a press formed part of an Example, in which FIG. 8(a) illustrates a plan view, FIG. 8(b) illustrates a cross-sectional view taken along line D-D′ of FIG. 8(a), and FIG. 8(c) illustrates three cross sections of a cross section A-A′, a cross section B-B′, and a cross section C-C′ of FIG. 8(a).

FIG. 9 is a graph indicating results of the Example (part 1).

FIG. 10 is a graph indicating results of the Example (part 2).

### DESCRIPTION OF EMBODIMENTS

### Background Leading to the Invention

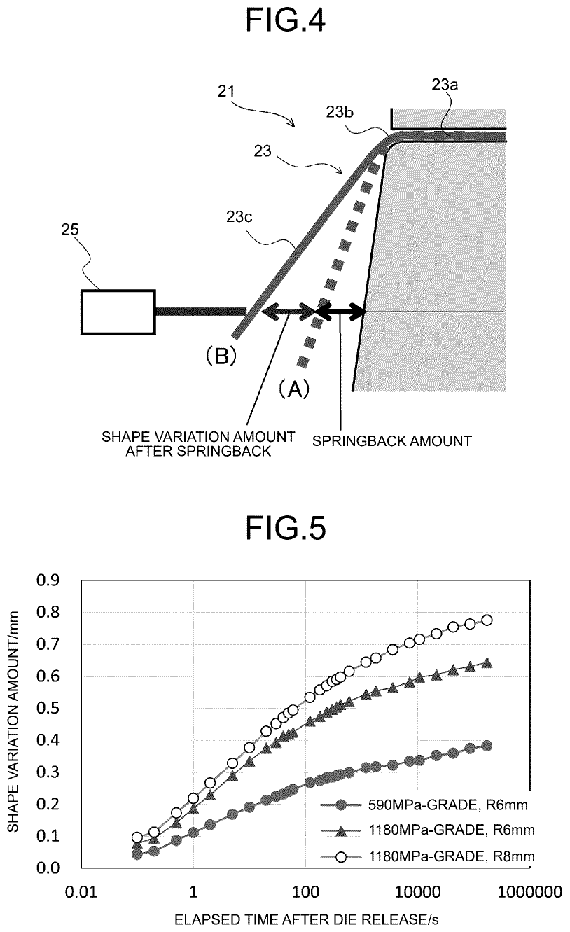

Prior to the description of the embodiments, the background leading to the present invention will be described. The inventors have studied a method of accurately predicting a dimensional prediction value of a stable shape after springback by a simple method. In the examination, as illustrated in FIG. 4, an L-bending die testing machine 21 was used to perform a test of press-forming (L-bending and forming) an L-shaped component 23 having a fixed piece portion 23a and a bent piece portion 23c continuous via a shoulder part of a punch 23b. In the test, a laser displacement meter 25 was installed on a side surface of the L-bending die testing machine 21 to irradiate the bent piece portion 23c with a laser, and the displacement amount of the bent piece portion 23c after die-releasing from the forming bottom dead center position was continuously measured. A dotted line (A) in FIG. 4 indicates the bent piece portion 23c at the time of springback immediately after die-releasing, and a solid line (B) indicates the bent piece portion 23c after deformation with the lapse of time thereafter. The horizontal distance between the dotted line (A) and the solid line (B) at the position in the height direction where the laser displacement meter 25 was installed was evaluated as the magnitude of the temporal shape variation (shape variation amount) after the springback.

The conditions of the L-shaped component 23 are as follows.
Tensile strength: 1180 MPa-grade, 590 MPa-grade
Blank shape: length 120 (mm)×width 90 (mm)×thickness 1.2 (mm)
Curvature radius of the shoulder part of a punch 23b: R6 mm, R8 mm

FIG. 5 is a graph indicating the above test results, where the horizontal axis represents the logarithm of the elapsed time(s) after die release, and the vertical axis represents the shape variation amount (mm) of the bent piece portion 23c. As indicated in FIG. 5, as the tensile strength is higher and the curvature radius of the shoulder part of a punch 23b of the L-bending and forming is larger, the shape variation amount of the bent piece portion 23c becomes larger. However, they are common in that the shape gradually shifts to a gradual change (inclination) with the lapse of time from immediately after die release, and the shape becomes stable (stable shape).

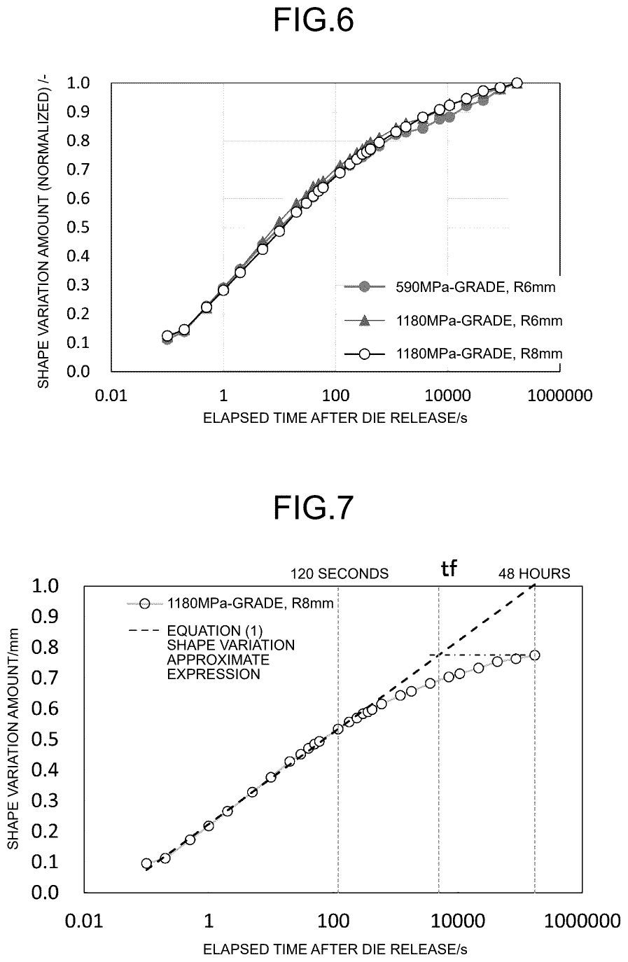

In FIG. 6, the shape variation amount from 0.1 seconds to 172800 seconds (48 hours) indicated in FIG. 5 is divided by the shape variation amount at 172800 seconds (48 hours) and normalized, that is, the shape variation amount at 172800 seconds is indicated as 1.0. As indicated in FIG. 6, the three curves illustrated in FIG. 5 substantially overlap each other. That is, even if factors affecting the amount of springback, such as the tensile strength of the metal sheet and the curvature radius of the shoulder part of a punch 23b of the L-bending and forming, are different, the temporal shape variation after springback occurs in the same pattern (shape variation path). This indicates that it is possible to predict the shape variation amount of the actual press formed part (L-shaped component 23) whose shape has become stable after the shape changes with the lapse of time after the springback, based on the shape variation amount at the time point when a predetermined time of several seconds to several minutes elapses immediately after the die release without waiting for 30 minutes or more after die-releasing the actual press formed part.

As indicated in FIG. 7, the shape variation amount from immediately after die release (0.1 seconds after die release) to a predetermined time (120 seconds after die release) is substantially a straight line on the semi-logarithmic graph. This straight line is expressed by the following linear Equation (shape variation approximate expression) regarding the logarithm of the elapsed time after die release. At least at two timings in a predetermined time that has elapsed from immediately after the die release (for example, 2 times within 120 seconds), the shape variation amount of the L-shaped component 23 at each timing is measured and the coefficients a and b of

Equation (1) above are specified based on the measurement results, thereby the shape variation amount corresponding to the elapsed time after the L-bending and forming can be obtained.

$$x = a \times log ( t ) + b \qquad ( 1 )$$

t: elapsed time from immediately after die release
x: shape variation amount at time t
a and b are coefficients

However, as indicated in FIG. 7, the relationship between the elapsed time after die release and the shape variation amount is such that the shape variation due to the temporal change after the actual springback is nonlinear and gradually shifts to a gentle variation (inclination) with the lapse of time from immediately after die release, and the shape becomes stable (stable shape). Therefore, at the time point of 172800 seconds (48 hours), a deviation occurs between a prediction value of the shape variation amount, which is calculated by the shape variation approximate expression (linear Equation) of Equation (1), and the actual shape variation amount, and correction is necessary. Thus, t (elapsed time tf after die release) in Equation (1) at the time the prediction value of the shape variation amount calculated by Equation (1) becomes equal to the actual shape variation amount after the lapse of 48 hours (172800 seconds) after the L-bending and forming was obtained. Of a case where, at two timings (first time: t1 seconds, second time: t2 seconds) within 120 seconds immediately after die release, the shape variation amount of the L-shaped component 23 at each timing is measured and the coefficients a and b of Equation (1) are specified based on the measurement results, Table 1 collectively indicates the above conditions and results.

### [Table 1]

TABLE 1

| | | | | | tf(s) that | Error of shape | |
|---|---|---|---|---|---|---|---|
| | | | | | becomes | variation amount | |
| | | | | | equal to | when tf = 5938 | |
| | | | Coefficients of | | shape | seconds is | |
| | | | shape variation | | variation | substituted into t of | |
| | Elapsed time | | approximate | | amount | shape variation | |
| | after forming | | expression | | after lapse | approximate | |
| | t1(s) | t2(s) | a | b | of 48 hours | expression | |
| 590 Mpa-grade | 30 | 60 | 0.073 | 0.116 | 4357 | 0.010 mm | 3% |
| R6 mm | 60 | 120 | 0.068 | 0.124 | 5843 | 0.000 mm | 0% |
| 1180 Mpa-grade | 30 | 60 | 0.106 | 0.236 | 6808 | −0.006 mm | −1% |
| R6 mm | 60 | 120 | 0.116 | 0.218 | 4554 | 0.013 mm | 2% |
| 1180 Mpa-grade | 30 | 60 | 0.140 | 0.246 | 6218 | 0.003 mm | 0% |
| R8 mm | 60 | 120 | 0.133 | 0.258 | 7845 | 0.016 mm | −2% |

As indicated in Table 1, the elapsed time tf after die release at which the prediction value of the shape variation amount calculated by Equation (1) becomes equal to the actual shape variation amount 48 hours after die release was minimum 4357 seconds to maximum 7845 seconds, and the average was 5938 seconds. The prediction value of the shape variation amount was calculated by using the coefficients a and b of the shape variation approximate expression in Equation (1) and substituting the average value tf=5938 seconds into the elapsed time t after die release in Equation (1), and was compared with the shape variation amount after reaching the actual stable shape after the lapse of 48 hours. As a result of the comparison, the error of the prediction value of the shape variation amount was within ±3% (average 2%), and thus good accuracy was obtained.

In Table 1, the two measurement timings were set at the elapsed time after die release within 120 seconds. For this reason, of a case where the measurement timings were set at the elapsed time after die release from 120 seconds to 360 seconds, similarly, the coefficients a and b of Equation (1) were calculated, and the elapsed time tf after die release at which the prediction value of the shape variation amount becomes equal to the actual shape variation amount after the lapse of 48 hours after die release was obtained. Table 2 collectively indicates these conditions and results.

### [Table 2]

TABLE 2

| | | | | | tf(s) that | Error of shape | |
|---|---|---|---|---|---|---|---|
| | | | | | becomes | variation amount | |
| | | | | | equal to | when tf = 15600 | |
| | | | Coefficients of | | shape | seconds is | |
| | | | shape variation | | variation | substituted into t of | |
| | Elapsed time | | approximate | | amount | shape variation | |
| | after forming | | expression | | after lapse | approximate | |
| | t1(s) | t2(s) | a | b | of 48 hours | expression | |
| 590 Mpa- | 120 | 240 | 0.050 | 0.163 | 24807 | −0.004 mm | −1% |
| grade | 180 | 300 | 0.049 | 0.163 | 31190 | −0.009 mm | −3% |
| R6 mm | 240 | 360 | 0.042 | 0.182 | 15600 | −0.019 mm | −8% |
| 1180 Mpa- | 120 | 240 | 0.094 | 0.265 | 10887 | 0.027 mm | 6% |
| grade | 180 | 300 | 0.099 | 0.251 | 9117 | 0.036 mm | 7% |
| R6 mm | 240 | 360 | 0.090 | 0.275 | 12905 | 0.019 mm | 4% |
| 1180 Mpa- | 120 | 240 | 0.133 | 0.283 | 7845 | 0.057 mm | 9% |
| grade | 180 | 300 | 0.121 | 0.285 | 11453 | 0.032 mm | 5% |
| R8 mm | 240 | 360 | 0.111 | 0.305 | 16597 | 0.011 mm | 2% |

As indicated in Table 2, the elapsed time tf after die release at which the prediction value of the shape variation amount calculated by Equation (1) becomes equal to the actual shape variation amount 48 hours after die release was minimum 7845 seconds seconds to maximum 31190 seconds, and the average was 15600 seconds. In addition, the error between the shape variation amount, which was obtained by using the shape change approximate formula coefficients a and b in Equation (1) and substituting the average value tf=15600 seconds into the elapsed time t after die release in Equation (1), and the shape variation amount after reaching the actual stable shape was within ±9% (average 2%), and thus good accuracy was obtained. The present invention has been made based on the above examination results.

### First Embodiment

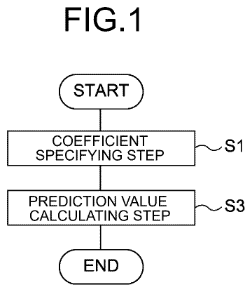

A press formed part shape prediction method according to the present embodiment is a method for predicting the shape of a press formed part whose shape has become stable after the shape changes with the lapse of time after springback instantaneously occurring immediately after die release in press forming of a metal sheet. As indicated in FIG. 1, the press formed part shape prediction method according to the present embodiment includes a coefficient specifying step and a prediction value calculating step. Each step will be described in detail below.

### <Coefficient Specifying Step>

The coefficient specifying step is a step of measuring, at least at two timings in a predetermined time that has elapsed from immediately after the die release, the shape variation amount of the specific portion of the press formed part at each timing, and specifying coefficients a and b in the following Equation (1) as coefficients a1 and b1 based on the measurement results.

$$x = a \times log ( t ) + b \qquad ( 1 )$$

where t is an elapsed time from immediately after die release, and
x is a shape variation amount at time t.

The specific portion and the variation amount in the shape variation amount of the specific portion of the press formed part measured in the coefficient specifying step can be appropriately set, but are preferably set as follows, for example.
Variation amount of a distance between two specified points of the press formed part
Variation amount of a distance between one specified point of the press formed part and one specified point of a reference jig
Variation amount of an angle between a line segment between two specified points of the press formed part and a line segment between two specified points of the reference jig
Variation amount of a curvature of the specific portion on a surface of the press formed part
Variation amount of an angle formed by line segments between two sets of two points sandwiching one or more bend ridges in the press formed part

### <Prediction Value Calculating Step>

The prediction value calculating step is a step of obtaining Xf, which is a prediction value of the shape variation amount of the specific portion in the press formed part whose shape has become stable, by substituting a time tf set in advance according to the timing of the measurement of the shape variation amount into the following Equation (2).

$$Xf = a 1 \times log ( tf ) + b 1 \qquad ( 2 )$$

where tf is a time set in advance, and
a1 and b1 are values specified in the coefficient specifying step.

In the prediction value calculating step, in a case where two timings are within 120 seconds immediately after die release, tf is set to a numerical value in the range of 4400 to 7800 seconds as in the range of tf indicated in Table 1. In addition, in a case where two timings are from 120 seconds to 1800 seconds immediately after die release, tf is set to a numerical value in the range of 7900 to 31000 seconds as in the range of tf indicated in Table 2.

In the press formed part shape prediction method of the present embodiment, at least two dimension measurements and measurement timings are recorded after press forming, and predetermined calculation work is performed. As a result, it is possible to predict the stable shape of the press formed part without waiting for a time (for example, 30 minutes) during which the dimension is to be generally stabilized after die release. Whether the shape of the press formed part after being stable finally achieves the target dimensional accuracy can be predicted at an early stage.

### Second Embodiment

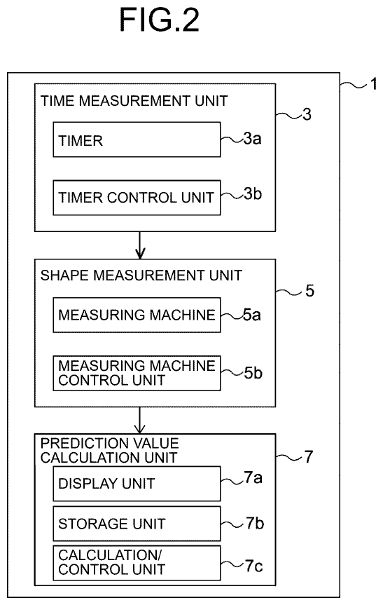

The present embodiment relates to a press formed part shape prediction apparatus 1 that executes the press formed part shape prediction method according to the first embodiment. The press formed part shape prediction apparatus 1 according to the present embodiment predicts a shape of a press formed part whose shape has become stable after the shape changes with the lapse of time after springback instantaneously occurring immediately after die release in press forming of a metal sheet. Specifically, as illustrated in FIG. 2, the press formed part shape prediction apparatus 1 according to the present embodiment includes a time measurement unit 3, a shape measurement unit 5, and a prediction value calculation unit 7. Each configuration will be described below.

### <Time Measurement Unit>

The time measurement unit 3 measures an elapsed time from immediately after die-releasing the press formed part. As a specific configuration example of the time measurement unit 3, one including a timer 3a and a timer control unit 3b that activates the timer 3a in conjunction with a die-releasing operation of a die and outputs a measurement start signal to the shape measurement unit 5 based on the measurement time of the timer 3a, can be exemplified.

### <Shape Measurement Unit>

At least at two timings in a predetermined time that has elapsed from immediately after the die release, the shape measurement unit 5 measures a shape variation amount of a specific portion of the press formed part at each timing, and records the measurement timing, the measurement portion, and the measurement value. The measurement may be performed at a timing when the signal is input based on the signal from the time measurement unit 3. The measurement timing, the specific portion, and the shape variation amount are similar to those described in the first embodiment.

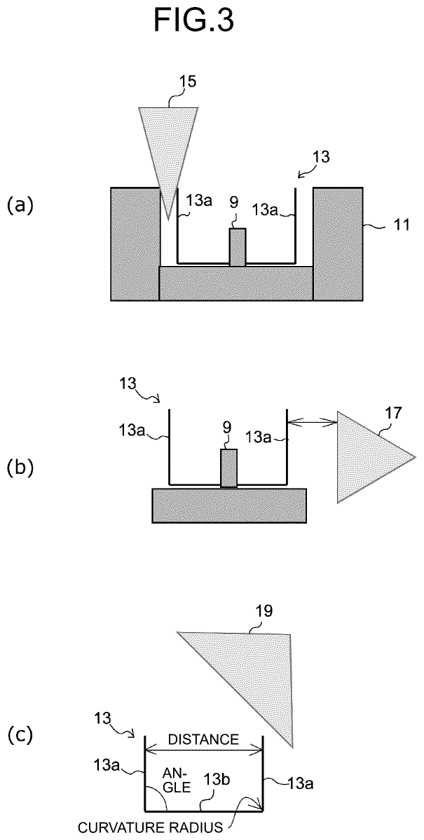

As a specific configuration example of the shape measurement unit 5, one including an optical or contact type measuring machine 5a and a measuring machine control unit 5b that controls the measuring machine 5a, can be exemplified. Examples of the measuring machine 5a and the measurement portion include those illustrated in FIG. 3. In the example illustrated in FIG. 3(a), a gap between a specific portion of a U-shaped cross section part 13, which is a press formed part fixed to an inspection jig 11 by a fixing pin 9, for example, a side wall portion 13a, and the inspection jig 11 is measured using a feeler gauge 15. In the example illustrated in FIG. 3(b), a range finder 17 is installed at a position away from the specific portion of the U-shaped cross section part 13 fixed to the inspection jig 11 by the fixing pin 9, for example, the side wall portion 13a, and a distance between the range finder 17 and the side wall portion 13a is measured. The range finder 17 may be an optical type or a contact type. Furthermore, the example illustrated in FIG. 3(c) is an example in which, using an optical type measuring machine 19, a distance between opposing side walls of the U-shaped cross section part 13 is measured, an angle between the side wall portion 13a and a bottom portion 13b is measured, and a curvature radius of a bending portion between the side wall portion 13a and the bottom portion 13b is measured.

### <Prediction Value Calculation Unit>

The prediction value calculation unit 7 specifies coefficients a and b in the following Equation (1) as coefficients a1 and b1 based on the measurement result of the shape measurement unit 5. Then, the prediction value calculation unit 7 obtains Xf, which is a prediction value of the shape variation amount of the specific portion in the press formed part whose shape has become stable, by substituting a time tf set in advance according to the timing of the measurement of the shape variation amount into Equation (2). The measurement timing and the time tf set in advance according to the timing are similar to those described in the first embodiment.

$$x = a \times log ( t ) + b \qquad ( 1 )$$

where t is an elapsed time from immediately after die release, and
x is a shape variation amount at time t.

$$Xf = a 1 \times log ( tf ) + b 1 \qquad ( 2 )$$

where tf is a time set in advance, and
a1 and b1 are values specified in the coefficient specifying step.

As a specific configuration example of the prediction value calculation unit 7, one including a display unit 7a, a storage unit 7b, and a calculation/control unit 7c is exemplified. The display unit 7a and the storage unit 7b are connected to the calculation/control unit 7c, and the respective functions are executed by a command from the calculation/control unit 7c. The display unit 7a displays a prediction value of the shape variation amount, or the shape. The storage unit 7b stores the prediction value of the shape variation amount, and stores a calculation program including Equations (1), (2), and the like. The calculation/control unit 7c inputs the measurement result of the shape measurement unit 5, calculates the prediction value of the shape variation amount based on Equations (1) and (2), and controls the display unit 7a and the storage unit 7b.

An operation of the press formed part shape prediction apparatus 1 configured as described above will be described. First, the time measurement unit 3 measures the elapsed time from immediately after die-releasing the press formed part from a die. At least at two timings in a predetermined time that has elapsed from immediately after the die release, the shape measurement unit 5 measures a shape variation amount of a specific portion of the press formed part at each timing, and records the measurement timing, the measurement portion, and the measurement value. The prediction value calculation unit 7 specifies the coefficients a and b in Equation (1) as the coefficients a1 and b1 based on the measurement result of the shape measurement unit 5. Then, the prediction value calculation unit 7 obtains Xf, which is a prediction value of the shape variation amount of the specific portion in the press formed part whose shape has become stable, by substituting the time tf set in advance according to the timing of the measurement of the shape variation amount into Equation (2), and records and/or displays the result.

### Example

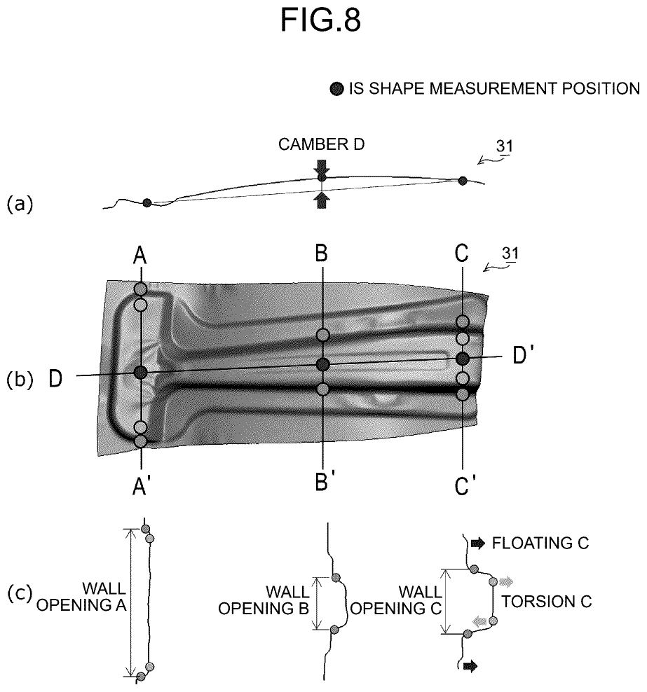

A test for confirming the effect of the present invention has been performed and will be described below. As illustrated in FIG. 8, a press formed part used in the test is a B-pillar component 31 having a substantially T-shaped protruding portion in plan view, and has a hat-shaped cross section and warps convexly upward in the longitudinal direction. A B-pillar press forming test (deep drawing (draw forming)) was performed using a steel sheet of 1180 MPa-grade, and thereafter, shape measurement was continuously performed at regular time intervals using a three-dimensional shape measuring machine.

Deformation due to springback in the B-pillar component 31 can be largely classified into camber deformation (camber), torsional deformation (torsion), and wall opening deformation (wall opening) of a cross section. As specific portions to be evaluated, a wall opening C of a cross section C-C′, a floating C (floating of a flange portion due to wall opening deformation), and a torsion C were set, as illustrated in FIG. 8. Then, after a lapse of 4 minutes after die release, the relationships between the elapsed time after die release and camber, torsion, and wall opening were measured for the specific portions in FIG. 8.

Based on the measurement results, identification of Equations (1) and (2) was performed. Assuming that a first elapsed time t1 after die release was 252 seconds and a second elapsed time t2 after die release was 1800 seconds, dimension measurement values of the wall opening C, the torsion C, and the floating C at the elapsed times were obtained, and coefficients (a, b) of the shape variation approximate expression of Equation (1) were calculated and set as a1 and b1. Table 3 indicates the values of the coefficients a1 and b1.

### [Table 3]

TABLE 3

| | a₁ | b₁ |
|---|---|---|
| Wall opening C | 0.064 | −0.155 |
| Torsion C | 0.030 | −0.073 |
| Floating C | 0.069 | −0.166 |

Since t1 and t2 were 120 seconds or more and 1800 seconds or less, a value to be substituted for t in Equation (2) was set to tf=20400 seconds within a range of 7900 to 31000 seconds, and tf=20400 seconds and coefficients a1 and b1 were substituted in Equation (2) to calculate a prediction value of the shape variation. Then, the prediction value was compared with the dimension measurement value after 48 hours.

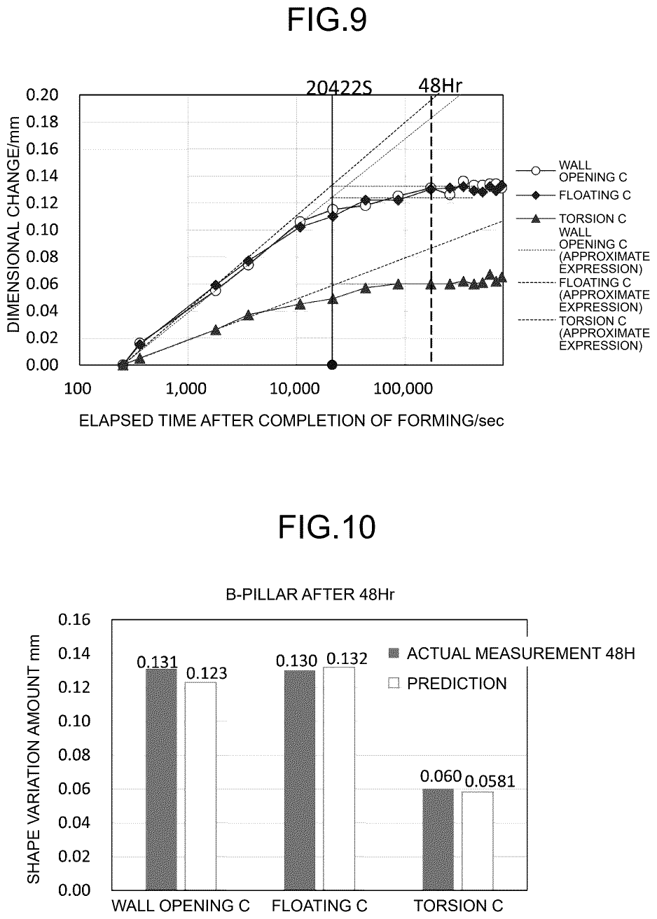

The results are indicated in FIGS. 9 and 10. FIG. 9 is a graph of a prediction value (broken line) and an actual measured value (plot), in which the vertical axis represents the dimensional change (mm) and the horizontal axis represents the elapsed time(s) after die release. FIG. 10 is a bar graph comparing the shape variation amount after 48 hours and the prediction value for each specific portion. From the results of FIGS. 9 and 10, the prediction accuracy of the present invention was as good as the wall opening C (−6%), the floating C (+1%), and the torsion C (−3%).

### INDUSTRIAL APPLICABILITY

According to the present invention, it is possible to provide a press formed part shape prediction method and a press formed part shape prediction apparatus capable of easily predicting a stable shape of a press formed part from a shape measurement result in several seconds to several minutes after forming.

### REFERENCE SIGNS LIST

1 PRESS FORMED PART SHAPE PREDICTION APPARATUS
3 TIME MEASUREMENT UNIT
3a TIMER
3b TIMER CONTROL UNIT
5 SHAPE MEASUREMENT UNIT
5a MEASURING MACHINE
5b MEASURING MACHINE CONTROL UNIT
7 PREDICTION VALUE CALCULATION UNIT
7a DISPLAY UNIT
7b STORAGE UNIT
7c CALCULATION/CONTROL UNIT
9 FIXING PIN
11 INSPECTION JIG
13 U-SHAPED CROSS SECTION PART
13a SIDE WALL PORTION
13b BOTTOM PORTION
15 FEELER GAUGE
17 RANGE FINDER
19 OPTICAL TYPE MEASURING MACHINE
21 L-BENDING DIE TESTING MACHINE
23 L-SHAPED COMPONENT
23a FIXED PIECE PORTION
23b SHOULDER PART OF A PUNCH
23c BENT PIECE PORTION
25 LASER DISPLACEMENT METER
31 B-PILLAR COMPONENT

1. A press formed part shape prediction method for predicting a shape of a press formed part whose shape has become stable after the shape changes with a lapse of time after springback instantaneously occurring immediately after die release in press forming of a metal sheet, the method comprising:
a coefficient specifying step of
measuring, at least at two timings in a predetermined time that has elapsed from immediately after die release, a shape variation amount of a specific portion of the press formed part at each timing, and
specifying coefficients a and b in Equation (1) as coefficients a1 and b1 based on measurement results; and
a prediction value calculating step of obtaining Xf, which is a prediction value of the shape variation amount of the specific portion in the press formed part whose shape has become stable, by substituting a time tf set in advance according to the timing of measurement of the shape variation amount into Equation (2),
$$x = a \times log ( t ) + b \qquad ( 1 )$$
where t is an elapsed time from immediately after die release, and
x is a shape variation amount at time t,
$$Xf = a 1 \times log ( tf ) + b 1 \qquad ( 2 )$$
where tf is a time set in advance, and
a1 and b1 are values specified in the coefficient specifying step.

2. The press formed part shape prediction method according to claim 1, wherein in the prediction value calculating step, tf is set to a numerical value in a range of 4400 to 7800 seconds in a case where the two timings are within 120 seconds immediately after die release, and tf is set to a numerical value in a range of 7900 to 31000 seconds in a case where the two timings are from 120 seconds to 1800 seconds immediately after die release.

3. The press formed part shape prediction method according to claim 1, wherein the shape variation amount measured in the coefficient specifying step is one of: a variation amount of a distance between two points of the press formed part; a variation amount of a distance between one point of the press formed part and one point of a reference jig; a variation amount of an angle between a line segment between two points of the press formed part and a line segment between two points of the reference jig; a variation amount of a curvature of a surface of the press formed part; or a variation amount of an angle formed by line segments between two sets of two points sandwiching one or more bend ridges in the press formed part.

4. A press formed part shape prediction apparatus for predicting a shape of a press formed part whose shape has become stable after the shape changes with a lapse of time after springback instantaneously occurring immediately after die release in press forming of a metal sheet, the apparatus comprising:
a time measurement unit configured to measure an elapsed time from immediately after die release;
a shape measurement unit configured to
measure, at least at two timings in a predetermined time that has elapsed from immediately after the die release, a shape variation amount of a specific portion of the press formed part at each timing, and
record a measurement timing, a measurement portion, and a measurement value; and
a prediction value calculation unit configured to
specify coefficients a and b in Equation (1) as coefficients a1 and b1 based on a measurement result of the shape measurement unit, and
obtain Xf, which is a prediction value of the shape variation amount of the specific portion in the press formed part whose shape has become stable, by substituting a time tf set in advance according to the timing of measurement of the shape variation amount into Equation (2),
$$x = a \times log ( t ) + b \qquad ( 1 )$$
where t is an elapsed time from immediately after die release, and
x is a shape variation amount at time t,
$$Xf = a 1 \times log ( tf ) + b 1 \qquad ( 2 )$$
where tf is a time set in advance, and
a1 and b1 are values specified by the prediction value calculation unit.

5. The press formed part shape prediction method according to claim 2, wherein the shape variation amount measured in the coefficient specifying step is one of: a variation amount of a distance between two points of the press formed part; a variation amount of a distance between one point of the press formed part and one point of a reference jig; a variation amount of an angle between a line segment between two points of the press formed part and a line segment between two points of the reference jig; a variation amount of a curvature of a surface of the press formed part; or a variation amount of an angle formed by line segments between two sets of two points sandwiching one or more bend ridges in the press formed part.
